(19) United States
(12) Patent Application Publication
(10) Pub. No.: US 2003/0196198 A1
(43) Pub. Date: Oct. 16, 2003

(54) System and method for scheduling news stories based upon voting by viewers/listeners

(75) Inventors: Scott J. Broussard, Cedar Park, TX (US); Eduardo N. Spring, Round Rock, TX (US)

Correspondence Address: Jeffrey L. Streets, Suite 355, 13831 Northwest Freeway, Houston, TX, 77040, US

(73) Assignee: INTERNATIONAL BUSINESS MACHINES CORPORATION, Armonk, NY

(21) Appl. No.: 10/121,878

(22) Filed: Apr. 11, 2002

(51) Int. Cl. H04N 7/16; H04N 7/173

(52) U.S. Cl. 725/24; 725/9

(57) ABSTRACT

The method, computer program and system enable a broadcaster to provide real-time questions to a remote audience and to receive real-time feedback from that audience. The method comprises broadcasting a performance and an index of selectable subjects that may be included in the performance to an audience, receiving audience votes for the selectable subjects, tabulating the votes for the selectable subjects, and scheduling the selectable subjects within the broadcast performance based upon the tabulated votes. Feedback from viewers can be received, tabulated and utilized for programming decisions while a performance or presentation is still in progress. In order to improve accessibility and participation in the voting process, preferably the viewer/listener feedback is accommodated through a number of communications media, such as through a telephone call by a viewer/listener to a special number, a smart cable box, or a web-based index.

### BACKGROUND OF THE INVENTION

1. Field of the Invention

The present invention relates to a method and apparatus for broadcasting a performance. More particularly, the invention relates to a method and apparatus for obtaining viewer input regarding the subject matter included in the performance.

2. Description of the Related Art

The programming of various performances or presentations, such as a live television newscast or a radio talk show, may rely upon dated survey information about the preferences of viewers in the general listening area and the judgment of a producer. While the timeliness and accuracy of the survey information, and in fact the judgment of the producer, may be improved through training and experience, there are a number of limitations and risks associated with using only this type of information in programming the content of the performance or presentation.

First, survey information is inherently dated. In fact, the time and expense involved in selecting a sample of the audience, producing the survey questions to each member of the sample, and then collecting, tabulating and interpreting the survey responses, dictates that the survey will not be repeated frequently. This aspect of surveys is acceptable when the survey deals with information that remains relevant over a period of time and is not likely to suddenly change. For example, the question “Do you rent or own your current residence?” is a relevant question for a retailer to ask at any point in time, and the possible responses “I rent” or “I own” are likely to remain true for long periods of time. However, questions that are time-sensitive or deal with real-time issues do not lend themselves to traditional surveys.

Second, survey information is collected only from a “representative sample” of the audience, rather then the “actual” audience at any particular point in time. Accordingly, the programming may target a representative sample of individuals that either “have been” viewers/listeners or “may be” viewers/listeners, rather than targeting the individuals who actually “are” viewing or listening at the relevant moment of the performance. Consequently, the programming is based upon a collection of assumptions that may not hold true, such as the assumption that the “representative sample” will remain representative at all times and under all conditions and the assumption that the survey was so comprehensive that it address all future needs for information. While these assumptions may have been acceptable in the past, the assumptions fall short in a variety of circumstances.

Furthermore, programming decisions may be forced upon on audience that is left to accept the programming or go elsewhere. For example, a news program whose slogan and programming criteria declare “Local News Comes First”, may have found that their local audience generally prefers local news first. However, on any particular day that same local audience may be more interested in an issue of national or international scope.

Therefore, there remains a need for systems and methods that enable performances to be programmed on a real-time basis, representing the actual viewers/listeners. It would be desirable if the system and method allowed the broadcaster to post new issues, subjects or questions as they become relevant. It would also be desirable if the system and method were automated and allowed the viewership to respond through various types of communication media.

### SUMMARY OF THE INVENTION

The present invention provides a system that enables a broadcaster to provide real-time questions to a remote audience and to receive real-time feedback from that audience. The method comprises broadcasting a performance and an index of selectable subjects that may be included in the performance to an audience, receiving audience votes for the selectable subjects, tabulating the votes for the selectable subjects, and scheduling the selectable subjects within the broadcast performance based upon the tabulated votes. A performance is any audio, video or audio and video presentation that may be live, recorded or a combination of live and recorded presentations.

The step of scheduling may comprise determining the order in which the selectable subjects will be broadcast and/or determining the duration of each of the selectable subjects. The step of scheduling may consist of fixed priority scheduling. One or more commercials may be scheduled within the broadcast performance. A selectable subject having the greatest number of votes may be scheduled as the next subject in the broadcast performance, or alternatively, a selectable subject having the greatest number of votes may be scheduled after a commercial.

The performance and the index of selectable subjects are both part of a television broadcast. The broadcast performance of the selectable subjects is selected from a live performance, a pre-recorded performance and combinations thereof. In one embodiment, the performance is a newscast and the selectable subjects are news stories. The step of tabulating votes may be limited to the votes received during a specified portion of the performance.

The method of the present invention may further comprise prioritizing performance of each of the selectable subjects in accordance with the number of votes tabulated for each of the selectable subjects. In this embodiment, a numerical priority is assigned to each of the selectable subjects, wherein the numerical priority is between a minimum setpoint and a maximum setpoint. Upon completion of its broadcast, the priority of the selectable item is reduced.

With a numerical priority assigned, the method further comprises yielding the performance of one selectable subject in order to allow performance of another selectable subject receiving an equal priority. When necessary to choose between two or more selectable items having equal priority, the choice is made by a round-robin technique. The broadcast performance may be divided into time segments, allowing each of the selectable subjects to inherit the same priority that was assigned to that selectable subject during the previous time segment. Alternatively, the priority of each of the selectable subjects may be reset at the beginning of each time segment. Furthermore, the method may assign a high priority to any selectable item during a new segment if the selectable item was not broadcast in the previous segment.

The method may further comprise preempting a performance of one selectable subject in order to allow performance of another selectable subject receiving a greater number of votes. The method may further comprise preparing additional performance related to one of the selectable subjects having a greater number of tabulated votes than the number of votes tabulated for a selectable subject that is currently being performed, and then broadcasting the additional performance. The audience votes received against the selectable subjects, might offset the votes for a selectable subject.

The method may further comprise dividing the broadcast performance into time segments, and allowing each of the selectable subjects to accumulate votes tabulated during the previous time segment or, alternatively, resetting the number of votes tabulated for each of the selectable subjects at the beginning of each time segment.

The votes may be received from a device selected from a smart cable box, a telephone, a computer browser, a personal digital assistant, and combinations thereof. The votes may be received at the local cable provider and the votes forwarded to the broadcast studio.

The performance may be broadcast through a first device type and the votes received from a second device type. The first device and the second device may each be independently selected from a smart cable box, a telephone, a computer browser, a personal digital assistant, and combinations thereof. Alternatively, the votes may be received from two or more different device types, wherein the device types are selected from a smart cable box, a telephone, a computer browser, and a personal digital assistant.

Another alternative may be that the performance is broadcast through a first device type and the index is broadcast through a second device type.

### BRIEF DESCRIPTION OF THE DRAWINGS

FIG. 1 is a schematic diagram of a system suitable for allowing real-time feedback from an audience in accordance with the present invention.

FIG. 2 is flowchart of a process for scheduling the subject matter of a broadcast performance on the basis of dynamic responses from an audience.

### DETAILED DESCRIPTION

The present invention provides a system that enables a broadcaster to provide real-time questions to a remote audience and to receive real-time feedback from that audience. The system may utilize communications media selected from telephone networks, computer networks, cellular or satellite networks, cable networks, and combinations of these media. The same or different media may be used to broadcast the performance to viewers, broadcast an index of questions or subjects to viewers, and receive responses or votes from viewers. It is an advantage of the present system that feedback from viewers can be received, tabulated and utilized for programming decisions while the performance or presentation is still in progress.

One preferred application for the present invention is the prioritization and scheduling of news stories. Accordingly, an index of news stories that a news channel believes are important to viewers is broadcast simultaneous to the broadcast of the news program, although the index and news program may be broadcast through the same or different communications media. The viewers/listeners of the news program provide feedback on news story selection in the form of positive or negative votes. The news program may use the priority data collected from the viewers/listeners in a number of manners, specifically including, without limitation, determining the inclusion or exclusion of particular news stories, determining the order of news stories, and determining the amount of time to spend on a news story. Most preferably, the news organization that produces the news program will develop their news stories with a view towards dynamically scheduling the broadcast of news stories. For example, each news story may be developed with breaking points, which are predefined segment boundaries, where the news story may be interrupted by a higher priority news story or enabling the news story to be scheduled with greater flexibility depending upon other priorities or commercial schedules. Additionally, each new story may have optional segments that can be added with little advance notice, such as a tentative videoconference interview with a noted expert.

Preferably, the viewer/listener feedback is accommodated through a number of communications media in order to improve accessibility and participation in the voting process. For example, votes may be received through a telephone call from a viewer/listener into a special telephone number where a telephone system plays the subject index and records votes entered into the telephone keypad. Further, a “smart” cable box may allow the viewer to request that the subject index be displayed and then allow the viewer to vote for a subject on the index. Additionally, a web-based index may be posted and accessible to the viewer/listener in manner that facilitates collection of votes for or against a news story. Any or all of the foregoing communications may be used in combination, with the votes being tabulated by a server.

A particularly preferred method for collecting votes allows viewers to vote through local communications, such as a local telephone number, to a local cable provider who tabulates votes and periodically, or on demand, forwards the votes to the local, regional or national studio.

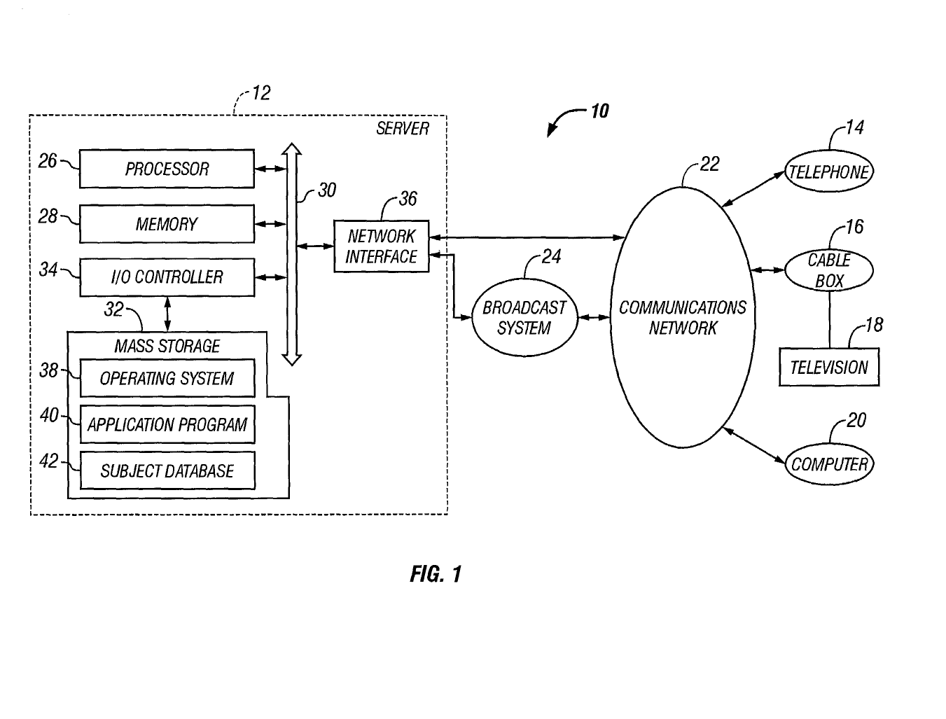

FIG. 1 is a schematic diagram of a system 10 suitable for allowing real-time feedback from an audience and real-time scheduling of a broadcast in accordance with the present invention. A server 12 is provided in communication with a telephone 14, a cable box 16 coupled to a television 18, and a computer 20 through a communications network 22. Further, a broadcast system 24 is provided in communication with the communication network 22 in order to broadcast a performance to one or more of the devices 14, 16, 18, 20.

The communications network 22 may include permanent connections, such as wire, coaxial cable or fiber optic cables, or temporary connections made through telephone lines or wireless communications. Personal computers and servers may be represented by a variety of computing devices, such as mainframes, personal computers, personal digital assistants and Internet-connected cellular telephones. The network may include additional servers, routers and other devices not shown. Specifically, the network 22 may include a cable television network, a telephone network, and a global computer communications network, such as the Internet, representing a worldwide collection of networks and gateways that use the TCP/IP suite of protocols to communicate with one another. Of course, the system 10 may also include a number of different types of networks, such as, for example, an intranet, a local area network (LAN), or a wide area network (WAN).

The server 12 includes conventional components such as a processor 26, memory 28 (e.g. RAM), a bus 30 that couples the processor 26 and memory 28, a mass storage device 32 (e.g. a magnetic hard disk and/or an optical storage disk) coupled to the processor 26 and memory 28 through an I/O controller 34 and a network interface 36, such as a conventional network interface card.

The present invention may be implemented in a variety of software environments. A typical operating system 38 may be used to control program execution within the server 12. The server 12 includes a conventional server software program such as IBM's Websphere®, for administering the interaction with equipment users. It will be appreciated that the present invention may be implemented in software that is stored as executable instructions on a computer readable medium of the server 12, such as the mass storage device 32, or in memory 28. Application programs 40 and an operating system program 38 reside on the mass storage device 32 and are loaded into memory 28 for execution. The operating system program 38 manages the resources of the server 12.

The application programs 40 are end-user programs, performing tasks as required by the server, including management of the subject database 42. Similar architecture and software systems may be implemented on the personal computer 20.

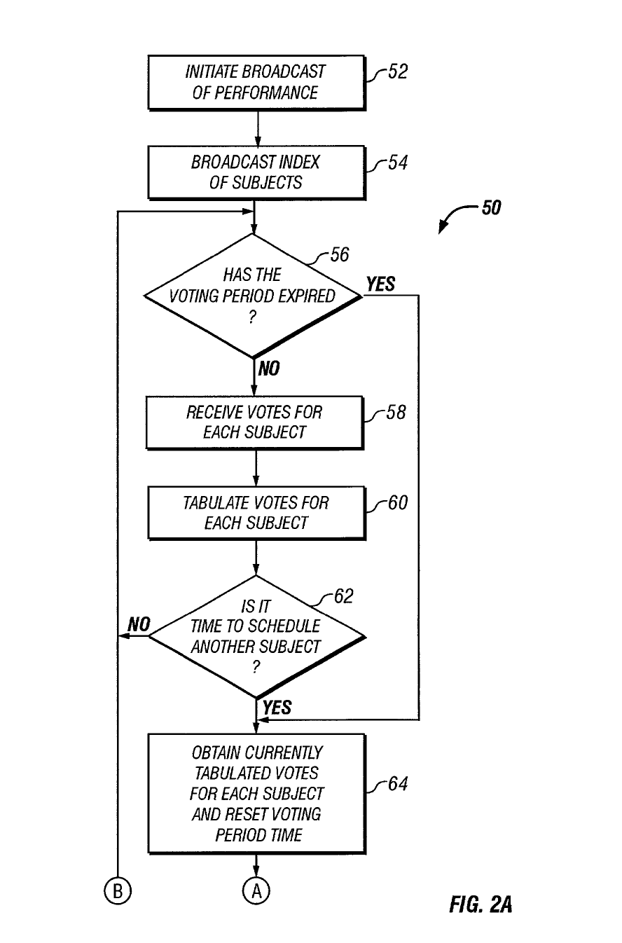

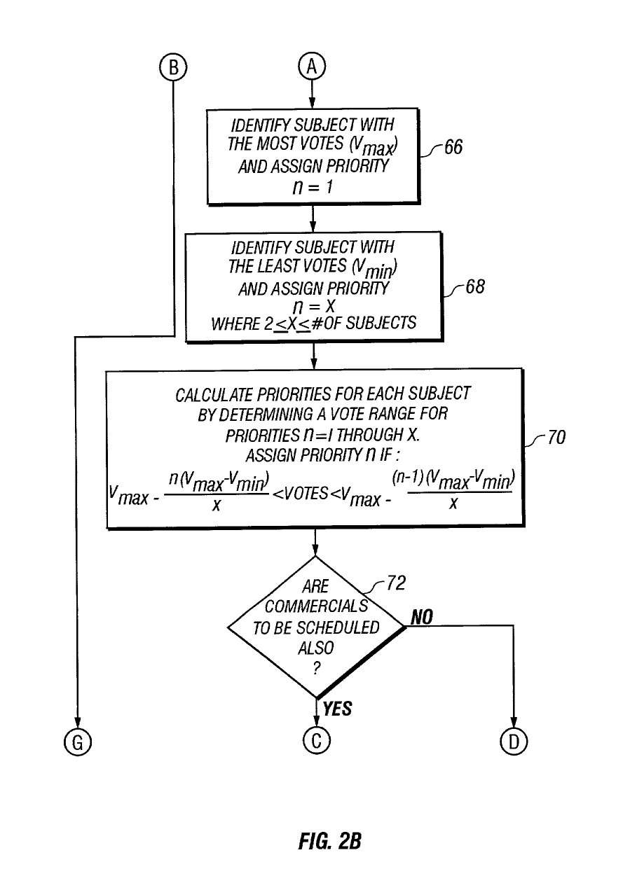

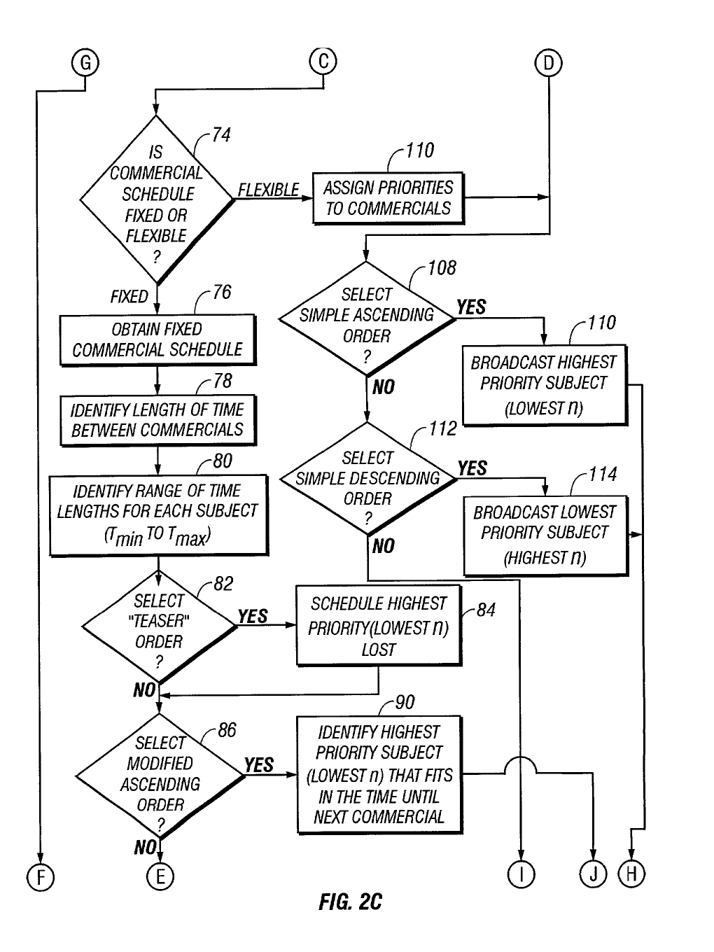

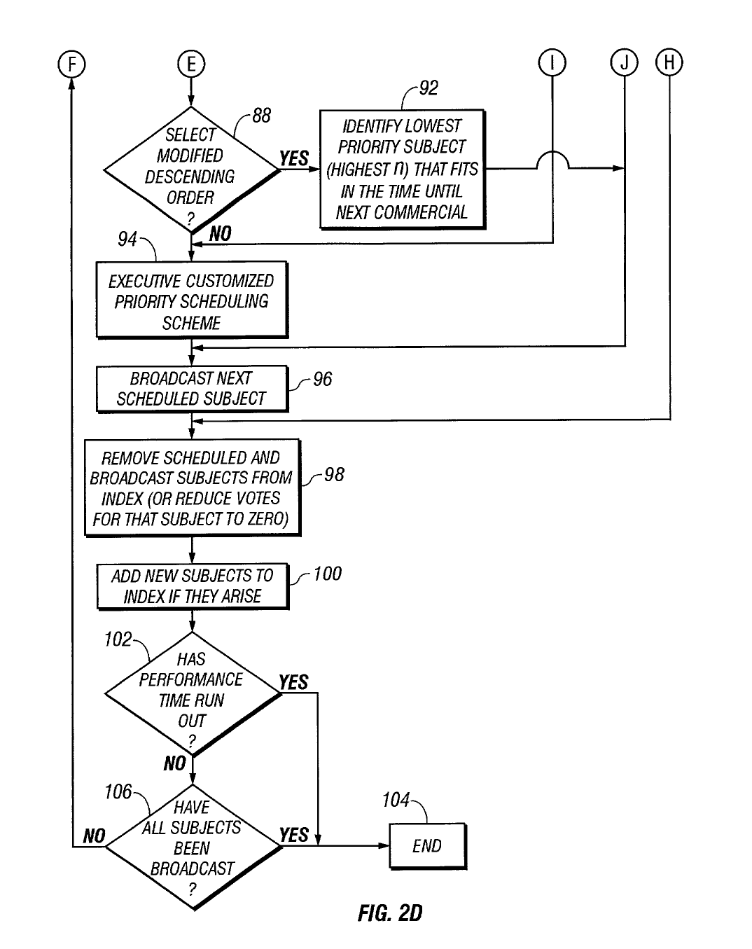

FIG. 2 is flowchart of a process 50 that may be implemented in software for scheduling the subject matter of a broadcast performance on the basis of dynamic responses from an audience. The process begins by initiating a broadcast of a performance, in state 52. In state 54, an index or listing of selectable subjects is also broadcast, yet the broadcast of the index may be made through the same or different media as the broadcast of the performance. In state 56, it is determined whether the voting period has expired, essentially to determine whether additional viewer/listener feedback is being accepted. If the voting period has not expired, then the server receives votes for each subject on the index in state 58, tabulates votes for each subject in state 60, and determines if it is time to schedule another subject for broadcasting in state 62. If it is not time to schedule another subject, then the process continues from state 62 to state 56. If it is determined in state 62 that it is time to schedule another subject or if it was determined in state 56 that the voting period has expired, then the currently tabulated votes are obtained for each subject on the index in state 64.

In state 66, the program identifies the subject with the most votes (Vmax) and assigns a priority of n=1. In state 68, the program identifies the subject with the least votes (Vmin) and assigns a priority of n=X, where X is a value chosen by the system administrator or other user, preferably wherein X is between 2 and the number of subjects included on the index. In state 70, the priorities are calculated for each subject on the index by determining a vote range for priorities n=1 through X. A priority of n is assigned to a subject if:

$$V max - \frac{n ( V max - V min )}{X} < ( votes for the subjects ) < V max - \frac{( n - 1 ) ( V max - V min )}{X}$$

It should be recognized that the foregoing method for calculating and assigning priorities is only a specific example, and that the present invention encompasses any number of possible prioritization schemes. In particular, the prioritization may include preempting performance and broadcast of one subject in order to broadcast performance of another subject receiving more votes, and further may include provisions to avoid starvation of subjects. For example, if one subject is of great interest to the audience, the audience may continue to vote heavily for that subject, even after the subject has been broadcast. The method may recognize the heavy voting based upon a pre-determined voting rate trigger. When triggered, the method may attempt to re-broadcast the story, even if a current subject being broadcast must yield to the subject having the high interest. The method may allow one subject to yield to a high interest subject at pre-determined yield points, which are predefined segment boundaries within each subject. In this manner, a yielding subject would not be cut off at, for example, mid-sentence, but would continue to broadcast to the predetermined yield point.

At the other extreme, one subject may generate so little interest from the audience and therefore receive so few votes that the subject would never broadcast. The administrator may still want to broadcast the subject as, for example, a public service announcement, and therefore instruct that the subject be broadcast a set number of times within a set time period, such as one time every two hours. The method may then, as the end of the time period approaches, artificially set a high priority to the subject, thereby ensuring that the subject is broadcast the required number of times within each designated time period.

If, in state 72, it is determined that commercials are also to be scheduled in the broadcast, then it is determined, in state 74, whether the commercial schedule is fixed or flexible. If there is a fixed commercial schedule, then the fixed commercial schedule is obtained in state 76, the length of time between commercials is identified in state 78, and the range of time lengths, between a minimum time (Tmin) and a maximum time (Tmax), for each subject is identified in state 80.

If, in state 82, the administrator has selected to schedule the subject in a “teaser” order, then the highest priority (lowest n value) subject is scheduled last in state 84. The “teaser’ order is presumably useful in holding the viewers/listeners until the end of the broadcast, since the subject they want most is withheld until last. Following states 82 and 84, it is determined whether the administrator has selected to schedule remaining subjects in ascending order, in state 86, or in descending order, in state 88. If the administrator has selected neither ascending nor descending order, then, in state 94, a customized priority scheme is executed.

If an ascending order is selected in state 86, then, in state 90, the remaining subject having the highest priority (lowest n value) that fits within the time until the next commercial is identified. If a descending order is selected in state 88, then, in state 92, the remaining subject having the lowest priority (highest n value) that fits within the time until the next commercial is identified. In state 96, the next scheduled subject is broadcast, whether that subject was scheduled in accordance with the highest priority subject identified in state 90, the lowest priority subject identified in state 92, or the customized priority scheduling scheme of state 94.

After scheduling or broadcasting a subject in state 96, then, in state 98, the subject that was scheduled or broadcast is removed from the subject index that is also being broadcast, to be added back to the list at the discretion of the administrator. In accordance with one alternative to removing the subject from the index, the tabulation of votes for a particular subject may be reduced to zero following broadcast of that subject. Then, if viewers continue to vote for that particular subject, that subject will accrue votes and the method will continue to treat the subject just as all the other listed subjects being voted upon by the viewers, and the subject may be re-broadcast based at a time based upon the number of votes the subject has obtained since being re-set to zero.

Furthermore, in state 100, new subjects may be added to the subject index from time to time as new subjects arise. In state 102, it is determined whether the time period available for the performance has run out or expired. If time has run out, then the process ends in state 104. If time has not run out, then, in state 106, it is determined whether all of the subjects on the index have been broadcast already. If all subjects have been broadcast, then the process ends in state 104. If time and subjects remain, then the process goes from state 106 back to state 56.

Referring back to state 72, if it is determined that no commercials are to be scheduled, then the process continues to state 108. Further referring to state 74, if it is determined that a flexible commercial schedule has been selected, then the commercials are assigned priorities in state 110 similar to the priorities previously assigned to the subjects, before advancing to state 108. If an ascending order is selected in state 108, then, in state 110, the remaining subject having the highest priority (lowest n value) is broadcast. Alternatively, if a descending order is selected in state 112, then, in state 114, the remaining subject having the lowest priority (highest n value) is broadcast. In either case, the process continues with state 98 described above.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A method comprising:
broadcasting a performance and an index of selectable subjects that may be included in the performance to an audience;
receiving audience votes for the selectable subjects;
tabulating the votes for the selectable subjects; and
scheduling the selectable subjects within the broadcast performance based upon the tabulated votes.

2. The method of claim 1, wherein the step of scheduling comprises determining the order in which the selectable subjects will be broadcast.

3. The method of claim 1, wherein the step of scheduling comprises determining the duration of each of the selectable subjects.

4. The method of claim 1, wherein the performance and the index of selectable subjects are both part of a television broadcast.

5. The method of claim 1, wherein the performance is a newscast and the selectable subjects are news stories.

6. The method of claim 1, wherein the step of tabulating votes is limited to the votes received during a specified portion of the performance.

7. The method of claim 1, further comprising:
prioritizing performance of each of the selectable subjects in accordance with the number of votes tabulated for each of the selectable subjects.

8. The method of claim 7, further comprising:
assigning a numerical priority to each of the selectable subjects, wherein the numerical priority is between a minimum setpoint and a maximum setpoint.

9. The method of claim 7, further comprising:
reducing the priority of a selectable item upon completion of its broadcast.

10. The method of claim 7, further comprising:
determining that a subject has not been broadcasted a preset number of times within a set period of time; and
increasing the priority of the subject without regard to a number of votes the subject received so that the subject is broadcasted.

11. The method of claim 9, wherein the priority is reduced to the minimum priority.

12. The method of claim 1, wherein the step of scheduling consists of fixed priority scheduling.

13. The method of claim 1, further comprising:
preempting performance of one selectable subject in order to allow performance of another selectable subject receiving a greater number of votes.

14. The method of claim 13, further comprising:
determining a location of a predetermined yield point in the one selectable subject; and
continuing to broadcast the one selectable subject to the predetermined yield point.

15. The method of claim 1, further comprising:
preparing additional performance related to one of the selectable subjects having a greater number of tabulated votes than the number of votes tabulated for a selectable subject that is currently being performed; and then
broadcasting the additional performance.

16. The method of claim 8, further comprising:
yielding the performance of one selectable subject in order to allow performance of another selectable subject receiving an equal priority.

17. The method of claim 8, further comprising:
choosing from two or more selectable items having equal priority by a round-robin technique.

18. The method of claim 8, further comprising:
dividing the broadcast performance into time segments; and
allowing each of the selectable subjects to inherit the same priority that was assigned to that selectable subject during the previous time segment.

19. The method of claim 8, further comprising:
dividing the broadcast performance into time segments; and
resetting the priority of each of the selectable subjects at the beginning of each time segment.

20. The method of claim 8, further comprising:
assigning a high priority to any selectable item during a new segment if the selectable item was not broadcast in the previous segment.

21. The method of claim 1, further comprising:
dividing the broadcast performance into time segments; and
allowing each of the selectable subjects to accumulate votes tabulated during the previous time segment.

22. The method of claim 1, further comprising:
dividing the broadcast performance into time segments; and
resetting the number of votes tabulated for each of the selectable subjects at the beginning of each time segment.

23. The method of claim 1, further comprising:
receiving the votes from a device selected from a smart cable box, a telephone, a computer browser, a personal digital assistant, and combinations thereof.

24. The method of claim 23, further comprising:
receiving the votes at the local cable provider; and
forwarding the votes to the broadcast studio.

25. The method of claim 1, wherein the performance is broadcast through a first device type and the votes are received from a second device type.

26. The method of claim 25, wherein the first device and the second device are each independently selected from a smart cable box, a telephone, a computer browser, a personal digital assistant, and combinations thereof.

27. The method of claim 1, wherein votes are received from two or more different device types, wherein the device types are selected from a smart cable box, a telephone, a computer browser, and a personal digital assistant.

28. The method of claim 1, wherein the performance is broadcast through a first device type and the index is broadcast through a second device type.

29. The method of claim 1, wherein the broadcast performance of the selectable subjects is selected from a live performance, a pre-recorded performance and combinations thereof.

30. The method of claim 2, further comprising:
scheduling one or more commercials within the broadcast performance.

31. The method of claim 30, further comprising:
scheduling a selectable subject having the greatest number of votes as the next subject in the broadcast performance.

32. The method of claim 30, further comprising:
scheduling a selectable subject having the greatest number of votes to follow a commercial.

33. The method of claim 1, further comprising:
receiving audience votes against the selectable subjects, wherein the votes against a selectable subject offset the votes for a selectable subject.

34. The method of claim 1, wherein the performance may be selected from audio, video and combinations thereof.

35. A computer program product comprising:
broadcasting instructions for broadcasting a performance and an index of selectable subjects that may be included in the performance to an audience;
receiving instructions for receiving audience votes for the selectable subjects;
tabulating instructions for tabulating the votes for the selectable subjects; and
scheduling instructions for scheduling the selectable subjects within the broadcast performance based upon the tabulated votes.

36. The computer program product of claim 35, wherein the scheduling instructions for scheduling comprises determining the order in which the selectable subjects will be broadcast.

37. The computer program product of claim 35, wherein the scheduling instructions for scheduling comprises determining the duration of each of the selectable subjects.

38. The computer program product of claim 35, wherein the performance and the index of selectable subjects are both part of a television broadcast.

39. The computer program product of claim 35, wherein the performance is a newscast and the selectable subjects are news stories.

40. The computer program product of claim 35, wherein the tabulating instructions for tabulating votes is limited to the votes received during a specified portion of the performance.

41. The computer program product of claim 35, further comprising:
prioritizing instructions for prioritizing performance of each of the selectable subjects in accordance with the number of votes tabulated for each of the selectable subjects.

42. The computer program product of claim 41, further comprising:
assigning instructions for assigning a numerical priority to each of the selectable subjects, wherein the numerical priority is between a minimum setpoint and a maximum setpoint.

43. The computer program product of claim 41, further comprising:
reducing instructions for reducing the priority of a selectable item upon completion of its broadcast.

44. The method of claim 41, further comprising:
determining instructions for determining that a subject has not been broadcasted a preset number of times within a set period of time; and
increasing instructions for increasing the priority of the subject without regard to a number of votes the subject received so that the subject is broadcasted.

45. The computer program product of claim 43, wherein the priority is reduced to the minimum priority.

46. The computer program product of claim 35, wherein the scheduling instructions for scheduling consists of fixed priority scheduling.

47. The computer program product of claim 35, further comprising:
preempting instructions for preempting performance of one selectable subject in order to allow performance of another selectable subject receiving a greater number of votes.

48. The computer program product of claim 47, further comprising:
determining instructions for determining a location of a predetermined yield point in the one selectable subject; and
continuing instructions for continuing to broadcast the one selectable subject to the predetermined yield point.

49. The computer program product of claim 35, further comprising:
preparing instructions for preparing additional performance related to one of the selectable subjects having a greater number of tabulated votes than the number of votes tabulated for a selectable subject that is currently being performed; and then
broadcasting instructions for broadcasting the additional performance.

50. The computer program product of claim 42, further comprising:
yielding instructions for yielding the performance of one selectable subject in order to allow performance of another selectable subject receiving an equal priority.

51. The computer program product of claim 42, further comprising:
choosing instructions for choosing from two or more selectable items having equal priority by a round-robin technique.

52. The computer program product of claim 42, further comprising:
dividing instructions for dividing the broadcast performance into time segments; and
allowing instructions for allowing each of the selectable subjects to inherit the same priority that was assigned to that selectable subject during the previous time segment.

53. The computer program product of claim 42, further comprising:
dividing instructions for dividing the broadcast performance into time segments; and
resetting instructions for resetting the priority of each of the selectable subjects at the beginning of each time segment.

54. The computer program product of claim 42, further comprising:
assigning instructions for assigning a high priority to any selectable item during a new segment if the selectable item was not broadcast in the previous segment.

55. The computer program product of claim 35, further comprising:
dividing the broadcast performance into time segments; and
allowing each of the selectable subjects to accumulate votes tabulated during the previous time segment.

56. The computer program product of claim 35, further comprising:
dividing instructions for dividing the broadcast performance into time segments; and
resetting instructions for resetting the number of votes tabulated for each of the selectable subjects at the beginning of each time segment.

57. The computer program product of claim 35, further comprising:
receiving instructions for receiving the votes from a device selected from a smart cable box, a telephone, a computer browser, a personal digital assistant, and combinations thereof.

58. The computer program product of claim 57, further comprising:
receiving instructions for receiving the votes at the local cable provider; and
forwarding instructions for forwarding the votes to the broadcast studio.

59. The computer program product of claim 35, wherein the performance is broadcast through a first device type and the votes are received from a second device type.

60. The computer program product of claim 59, wherein the first device and the second device are each independently selected from a smart cable box, a telephone, a computer browser, a personal digital assistant, and combinations thereof.

61. The computer program product of claim 35, wherein votes are received from two or more different device types, wherein the device types are selected from a smart cable box, a telephone, a computer browser, and a personal digital assistant.

62. The computer program product of claim 35, wherein the performance is broadcast through a first device type and the index is broadcast through a second device type.

63. The computer program product of claim 35, wherein the broadcast performance of the selectable subjects is selected from a live performance, a pre-recorded performance and combinations thereof.

64. The computer program product of claim 36, further comprising:
scheduling instructions for scheduling one or more commercials within the broadcast performance.

65. The computer program product of claim 64, further comprising:
scheduling instructions for scheduling a selectable subject having the greatest number of votes as the next subject in the broadcast performance.

66. The computer program product of claim 64, further comprising:
scheduling instructions for scheduling a selectable subject having the greatest number of votes to follow a commercial.

67. The computer program product of claim 35, further comprising:
receiving instructions for receiving audience votes against the selectable subjects, wherein the votes against a selectable subject offset the votes for a selectable subject.

68. A system comprising:
means for broadcasting a performance and an index of selectable subjects that may be included in the performance to an audience;
means for receiving audience votes for the selectable subjects;
means for tabulating the votes for the selectable subjects; and
means for scheduling the selectable subjects within the broadcast performance based upon the tabulated votes.

69. The system of claim 68, further comprising:
means for prioritizing performance of each of the selectable subjects in accordance with the number of votes tabulated for each of the selectable subjects.

70. The system of claim 69, further comprising:
means for assigning a numerical priority to each of the selectable subjects, wherein the numerical priority is between a minimum setpoint and a maximum setpoint.
